(19) United States
(12) Patent Application Publication
(10) Pub. No.: US 2018/0355292 A1
(43) Pub. Date: Dec. 13, 2018

(54) E.L. Solutions All-Purpose Cleaner

(71) Applicant: Lee Edwards Ellis Lynch, Irving, TX (US)

(72) Inventor: Lee Edwards Ellis Lynch, Irving, TX (US)

(21) Appl. No.: 15/398,732

(22) Filed: Mar. 16, 2017

(51) Int. Cl. C11D 7/44

(52) U.S. Cl. CPC C11D 7/44

(57) ABSTRACT

EL's Solutions All-Purpose cleaner is an all-organic, non-toxic, and edible multi use cleaner that cleans and removes dirt, germs, stains, and grease on kitchen sinks, floors, stove tops, counter tops, inside ovens, outside ovens, inside freezers/refrigerators, outside freezers/refrigerater's, walls, tables, toilets, tubs, bathroom/restroom sinks, furniture, mirrors, trash cans, shoes, clothes, computer surfaces, TV screens, monitor screens, modems, switches, routers, mobile device's screens, printers, mobile device's keyboards, and other electronic devices. EL's Solutions All-Purpose cleaner is used as an all-it-one cleaner and organic clear protectant for all motor vehicles. It will clean the outside paint surface of the vehicle and leave a biodegradable clear protective on it for 3 weeks. EL's Solutions All-Purpose cleaner also cleans and protects all interior surfaces in motor vehicles and motor vehicle's rims and wheels. The cleaner can be used with towels, paper towels, rag, putty/clay, and any cleaning utensil. EL's Solutions All Purpose cleaner also leaves a biodegradiable clear protective on all smooth surfaces for 3 weeks. It is safe for newborn babies, toddlers, and household pets.

The purpose and intent of this specification document is to detail the ingredients of EL's Solutions All-Purpose Cleaner, the process of making the EL's Solutions All-Purpose Cleaner's formula, and the uses for of EL's Solutions All-Purpose Cleaner. The specification version is the most recent version which was made on Jan. 8, 2017.

EL's Solutions All-Purpose Cleaner is made up of ingredients that are all organic products. EL's Solutions All-Purpose Cleaner is also edible (pending that the person eating the solution is not allergic to plants that the ingredients are derived from). EL's Solutions All-Purpose Cleaner's is a plant-based solution made from garlic, lemons, and oranges. After mixing these ingredients, the solution must sit for approximately 5 months to fully mix. Finally, this sample of completely mixed EL's Solutions All-Purpose Cleaner is ready to use. The EL's Solutions All-Purpose Cleaner cleans dirt, stains, rust, grime, oil, lime, and blood off if any surface (including human skin). The EL's Solutions All-Purpose Cleaner also leaves a biodegradable clear-protective coat on smooth surfaces.

### INSTRUCTIONS

Submerse garlic peel in water for 2 weeks. Sprain the garlic peel from the pre-solution and throw away garlic peel. Mix every 2 quarts of pre-solution with 1 fl. oz. of 100% lemon essential oil and 1 fl. oz. of 100% orange essential oil. Let sit for 3 to 6 months. Finally, the product is ready to be bottle and ready for use.

1-15. (canceled)

16: EL's Solutions All-Purpose cleaner is an all-organic, non-toxic, and edible multi use cleaner that cleans and removes dirt, germs, stains, and grease on kitchen sinks, floors, stove tops, counter tops, inside ovens, outside ovens, inside freezers/refrigerators, outside freezers/refrigerators, walls, tables, toilets, tubs, bathroom/restroom sinks, furniture, mirrors, trash cans, shoes, clothes, computer surfaces, TV screens, moinitor screens, modems, switches, routers, mobile device's screens, printers, mobile device's keyboards, and other electronic devices.

17: EL's Solutions All-Purpose cleaner is used as an all-it-one cleaner and organic clear protectant for all motor vehicles. It will clean the outside paint surface of the vehicle and leave a biodegradable clear protective on it for 3 weeks. EL's Solutions All-Purpose cleaner also cleans and protects all interior surfaces in motor vehicles and motor vehicle's rims and wheels. The cleaner can be used with towels, paper towels, rag, putty/clay, and any cleaning utensil.

18: EL's Solutions All-Purpose cleaner also leaves a biodegradable clear protective on all smooth surfaces for 3 weeks. It is safe for newborn babies, toddlers, and household pets.
